(19) United States
(12) Patent Application Publication
(10) Pub. No.: US 2008/0106968 A1
(43) Pub. Date: May 8, 2008

(54) Components for Static Micromixers, Micromixers Constructed from such Components and Use of such Micromixers for Mixing or Dispersing or for Carrying Out Chemical Reactions

(75) Inventors: Gerhard Schanz, Darmstadt (DE); Gerhard Sendelbach, Darmstadt (DE)

Correspondence Address: MICHAEL J. STRIKER, 103 EAST NECK ROAD, HUNTINGTON, NY, 11743, US

(73) Assignee: WELLA AG, Darmstadt (DE)

(21) Appl. No.: 10/563,348

(22) PCT Filed: Jun. 4, 2004
(86) PCT No.: PCT/EP04/06042

§ 371 Date: Sep. 19, 2007

(30) Foreign Application Priority Data
Jul. 25, 2003 (DE) 103 33 922.1

(51) Int. Cl. B01F 15/02

(52) U.S. Cl. 366/134

(57) ABSTRACT

Components for static micromixers, micromixers constructed from such components and processes carried out by the use of said micromixers are described. The components are in the form of a disk with at least one inlet opening (2) for introducing at least one feed stream into a linking channel (3) disposed in the plane of the disk and at least one outlet opening (4) for the outflow of the feed stream into a mixing zone (5), wherein the inlet opening (2) is connected in a communicating manner with the outlet opening (4) through the linking channel (3) disposed in the plane of the disk and wherein the linking channel (3) before opening into the mixing zone (5) is divided by microstructure units (6) into two or more part channels, the widths of the part channels being in the millimeter to submillimeter range and being smaller than the width of the mixing zone (5).

The micromixers can be used for mixing, homogenizing, dispersing, emulsifying, dissolving or gassing liquids or for carrying out chemical reactions and particularly combustion reactions.

The object of the invention are disk-shaped components for static micromixers, micromixers constructed from such disks, mixing and dispersing processes as well as processes for carrying out chemical reactions by use of such micromixers.

The objective of mixing at least two fluids is to attain a uniform distribution of the two fluids within a certain, as a rule short, time. In dynamic mixers, the mixing takes place by use of mechanically actuated agitators which cause turbulent flow conditions. Dynamic mixers have the drawback that because of the required mechanical components they cannot be readily reduced in size. In static mixers, the mixing takes place without the use of movable parts. These mixers can be reduced in size to give so-called static micromixers of which various embodiments are known. Static micromixers have the advantage that the size of the components can be reduced and that therefore they can be integrated into other systems such as heat exchangers and reactors. By cooperation between two or more components interconnected in a narrow space, additional possibilities exist in terms of process optimization. The very narrow distribution of mixing times achievable in static micromixers offers many possibilities of optimization of chemical reactions in terms of selectivity and yield. It is possible to achieve mixing times between 1 second and a few milliseconds, the mixing of gases taking place even much faster. The application potential of micromixers ranges from liquid-liquid and gas-gas mixing to the formation of liquid-liquid emulsions, gas-liquid dispersions and thus also to multiphase reactions and phase-transfer reactions.

One class of micromixers is based on diffusion-controlled mixing processes. To this end, alternately adjacent fluid lamellae with a thickness in the micrometer range are formed. By an appropriate selection of the geometry, it is possible to adjust the width of the fluid lamellae and thus the diffusion paths. Such static micromixers are described, for example, in DE 199 27 556 A1, DE 202 06 371 U1 and WO 02/089962. The drawback of micromixers based on diffusion between microscopic fluid lamellae is that a relatively low flow velocity is needed for creating and maintaining laminar flow conditions. This mixing principle allows only relatively low throughputs.

Also known are micromixers consisting of guide components provided with passing-through channels or of films provided with grooves which when superposed on one another form a number of channels for the different fluids that are to be mixed, the dimensions of the channels being in the micrometer range. The feed streams emerge from the channels into a mixing space as adjacent fluid lamellae, the mixing taking place by diffusion and/or as a result of turbulence (see, in particular, WO 97/17139 and the literature cited therein as well as WO 97/17133, WO 95/30475, WO 97/16239 and WO 00/78438). The fabrication of these components is relatively expensive and complicated, and as a result of the fluids to be mixed having to pass through a multiplicity of long and very narrow channels, the pressure losses are relatively high. If high throughputs are to be achieved, the use of powerful pumping systems may be required.

The object of the invention is to provide a process and a device for mixing at least two fluids which at low pressure losses permit fast and intensive mixing by use of the required components which occupy a small space and are simple to fabricate.

In the following, by the term “fluid” is meant a gaseous or liquid substance or a mixture of such substances that can contain one or more solid, liquid or gaseous dissolved or dispersed substances. The term “mixing” also includes the processes of dissolving, dispersing and emulsifying. Hence, the term “mixture” comprises solutions, liquid-liquid emulsions and gas-liquid and solid-liquid dispersions.

The above-indicated objective is reached by way of static micromixers that are provided with the components of the invention. A component of the invention has the shape of a disk which

has at least one inlet opening for the introduction of at least one feed stream into a linking channel lying in the plane of the disk and at least one outlet opening for the outflow of the feed stream into a mixing zone lying in the plane of the disk,

wherein the inlet opening is connected with the outlet opening in a communicating manner through a linking channel lying in the plane of the disk and

wherein the linking channel before opening into the mixing zone is divided by microstructure units into two or more part channels, the widths of the part channels being in the millimeter to submillimeter range and being smaller than the width of the mixing zone.

The term “part channels” also includes division of the feed stream into part streams by built-in microstructure parts just before the outflow of said feed stream into the mixing zone. The dimensions, particularly the lengths and widths of these built-in parts, can be in the range of millimeters or preferably smaller than 1 mm. The part channels are preferably shortened to the length that is absolutely needed for flow control and, hence, for a certain throughput they require comparatively low pressures. The length-to-width ratio of the part channels is preferably in the range from 1:1 to 20:1, particularly from 8:1 to 12:1and most preferably about 10:1. The built-in microstructure parts are preferably configured in such a way that the flow rate of the feed stream at the outlet into the mixing zone is greater than at the inlet into the linking channel and preferably also greater than the flow rate of the product stream through the mixing zone.

The linking channel and part channels disposed on the disks can be provided in free form. Both the disks and each channel disposed thereon can vary in height, width and thickness so as to also be able to convey different media and different quantities. The basic shape of the disks can be of any desired kind, for example it can be round or circular or else elliptical or angular, for example rectangular or square. The disk shape can also be optimized in terms of simple fabrication or in terms of minimum weight or minimum unused surface. The outlets of the part channels can be arranged in any desired manner from a straight line to any geometric form. For example, the outlet openings can be arranged on a circular line, particularly when the mixing zone is completely enclosed by the plane of the disk. Two or more than two components (A, B, C etc) can be conveyed in a disk and mixed in identical or different quantity ratios. The part channels can be disposed at any angle to each other or relative to the line on which the outlets into the mixing zone are disposed. Several part channels, each conveying, for example, component A, can be arranged side by side, and in the adjacent section of the same disk there can be arranged side by side several part channels conveying, for example, component B. However, the components can, by means of additional through-holes and additional part channels in the disks, be configured so that components A, B etc alternate from part channel to part channel in the same disk.

At their entrance to the mixing zone, the part channels preferably have a width in the range from 1 μm to 2 mm and a depth in the range from 10 μm to 10 mm and most preferably a width in the range from 5 μm to 250 μm and a depth in the range from 250 μm to 5 mm.

The linking channel can have a variable width. Preferably, the ratio of the greatest width of the linking channel and/or the width of the inlet opening to the width of the part channels at their outlet into the mixing zone is greater than 2 and most preferably greater than 5. The ratio of the width of the mixing zone to the width of the part channels is preferably greater than 2 and most preferably greater than 5.

The disk-shaped components can be from 10 to 1000 μm thick. The height of the channels is preferably less than 1000 μm and most preferably less than 250 μm. The wall thickness of the built-in microstructure components and of the channel bottom is preferably less than 100 μm and most preferably less than 70 μm.

In a particular embodiment, at least one of the inlet or outlet openings or the mixing zone is completely enclosed by the plane of the disk. In this case, the openings are in the form of, for example, round or angular, for example rectangular, recesses. In the case of an enclosed mixing zone, the elliptical or circular shape is preferred. The part channel can taper off in the form of nozzles in the direction of the mixing zone. The part channels can be linear or bent in the shape of a spiral. The part channels can enter into the mixing zone at a right angle relative to the circumferential line of the mixing zone or at an angle different from 90°0. When in the event that the angle is different from a right angle a stack of several mixer disks is formed, preferably the disks with opposite deviation from a right angle are adjacent to each other. Similarly, when a stack of several mixer disks is formed, then, in the event that the course of the part channels is spiral-shaped, disks with oppositely oriented direction of spiral rotation are preferably adjacent to each other.

The linking channel between the openings is preferably formed by an indentation. The inlet opening and/or outlet opening or the mixing zone, however, can also be disposed at the edge of the disk or be in the form of recesses at the edge of the disk.

In another particular embodiment, there are present at least two inlet openings for at least two different feed streams, each inlet opening being connected with the mixing zone through a linking channel. In this case, there are preferably two outlet openings for two different feed streams on opposite sides of the mixing zone, the mixing zone preferably being in a position completely enclosed within the disk plane.

Suitable materials of construction for the components are, for example, metals, particularly corrosion-resistant metals, such as, for example, stainless steel, as well as glasses, ceramic materials or plastic materials. The components can be fabricated by techniques for producing microstructures on surfaces, techniques that in and of themselves are known, for example by etching or milling of metals or by embossing or injection-molding of plastics.

The static micromixer of the invention has a housing with at least 2 inlets for fluids and at least one outlet for fluids. In the housing are located at least two disk-shaped micromixer components of the invention, arranged in a stack. Stacks can be formed from any number of disks, permitting a through-flow commensurate with the height of the stack. To ensure the same pressure throughout the mixer, in the case of greater lengths the fluid can be introduced at several points. Grooves or ribs can be used for purposes of stacking and aligning. The disks are superposed on one another so that the inlet openings form subsidiary channels for introducing a particular feed stream and the outlet openings or the mixing zone together form a main channel for removing the product stream, the main channels and subsidiary channels extending through the stack. Overall, a micromixer can have, for example, at least 5, 10, 100 or even more than 1000 part channels and it consists of a stack of disks having several part channels.

Preferably, each part stream of a first feed A flowing from an outlet opening of a disk into the mixing zone is directly adjacent to a part stream of a second feed B flowing from an outlet opening of an adjacent disk into the mixing zone. In the mixing zone, the mixing takes place by diffusion and/or turbulence.

In another embodiment of the micromixer, the linking channels of the disks are formed by indentations. Before they end in the mixing zone, the linking channels are divided into part channels by microstructure units disposed on the disks. In an alternative embodiment, the linking channels of the disks are formed as recesses in the disks, the disks being arranged as intermediate disks between a cover disk and a bottom disk, and the linking channels, before they end in the mixing zone are divided into part channels by microstructure units disposed on the cover disk and/or bottom disk. Heat-supplying or heat-removing heat exchangers can be integrated into the micromixers of the invention.

Above all, the micromixer of the invention is also suited for chemical reactions of gaseous components, particularly for combustion reactions. An object of the invention therefore is a combustion reactor, for example a gas burner or an oil burner. The combustion reactor contains a micromixer of the invention as an essential constituent as well as at least a first connection for supplying a combustible liquid or gaseous medium and at least one second connection for supplying an oxygen-containing medium promoting the combustion reaction, for example air. The supply of these components can be arranged so that certain quantities characterizing the reaction are optimized. This is true, in particular, for the flame temperature and the products formed by the reaction. In the case of combustion of a burnable gas (for example methane) with atmospheric air, the formation of nitrogen oxides can be minimized by reducing the combustion temperature. The flame can be made concentrated or divergent by an appropriate convex or concave configuration of the outlet openings. By an appropriate arrangement of the channels, it is also possible to achieve locally limited auxiliary flames supplied from one of the subsidiary channels with gas at constant pressure. By connecting the other subsidiary channels, the reaction can then be started. Cylinder-shaped reaction chambers (mixing zones) for creating nozzle-like burners are also possible. Besides media of the same kind such as gas/gas, different kinds of media such as gas/liquid can also be mixed, particularly to burn combustible liquids, for example gasoline or oil.

An object of the invention is also a process for mixing fluid components, whereby at least two fluid feed streams that at first are kept separated can be mixed with one another, the mixing being carried out by use of at least one component of the invention or of a static micromixer of the invention. To this end, the flow rate of the feed stream or feed streams in the mixing zone is preferably greater than the flow rate of the product mixture within the mixing zone. Particularly preferred are mixer configurations and flow rates at which turbulence is created in the mixing zone and the mixing in the mixing zone takes place at least partly as a result of turbulence.

The mixing process of the invention comprises in particular also homogenization processes, processes for the production of dispersions, emulsions or solutions as well as for the gassing of liquids. To this end, a continuous liquid phase is mixed with at least one insoluble fluid phase that is to be dispersed or with at least one soluble fluid phase by use of at least one component of the invention or of a static micromixer of the invention. The two phases can either be introduced through various subsidiary channels or one phase (preferably the continuous phase) is introduced through the main channel and the second phase through a subsidiary channel.

Another object of the invention is a process for carrying out chemical reactions whereby

at least two fluid feed streams which at first are kept separated and which contain or consist of reactive components are mixed with one another and whereby

during or after the mixing a chemical reaction between the components takes place spontaneously or is induced by supplying energy or by a suitable catalyst and whereby

the mixing is carried out by use of at least one component of the invention or at least one static micromixer of the invention.

To increase the capacity of the process of the invention, the number of channels in the disks can be increased or the number of the disks superposed on one another in a micromixer can be increased or several micromixers can be connected together in parallel and operated as a module. It is also possible to operate two or more micromixers connected in series. It is particularly advantageous if in this case a coarse premix is first made with a micromixer having larger channel diameters and then with micromixers with increasingly smaller channel diameters.

In the following, exemplary embodiments of the components and micromixers of the invention are explained by reference to the drawings.

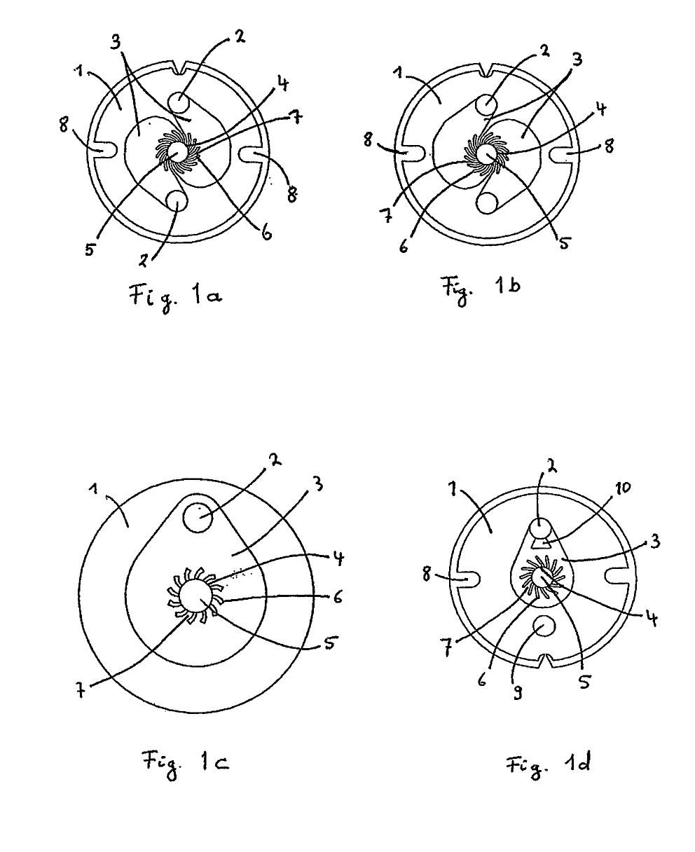

FIG. 1a-b shows mixing disks with two inlet openings for two feed streams and wherein the inlet opening and outlet opening are enclosed,

FIG. 1c shows a mixing disk with a single inlet opening and wherein the inlet opening and outlet opening are enclosed,

FIG. 1d shows a mixing disk with enclosed inlet opening, through-flow opening and outlet opening,

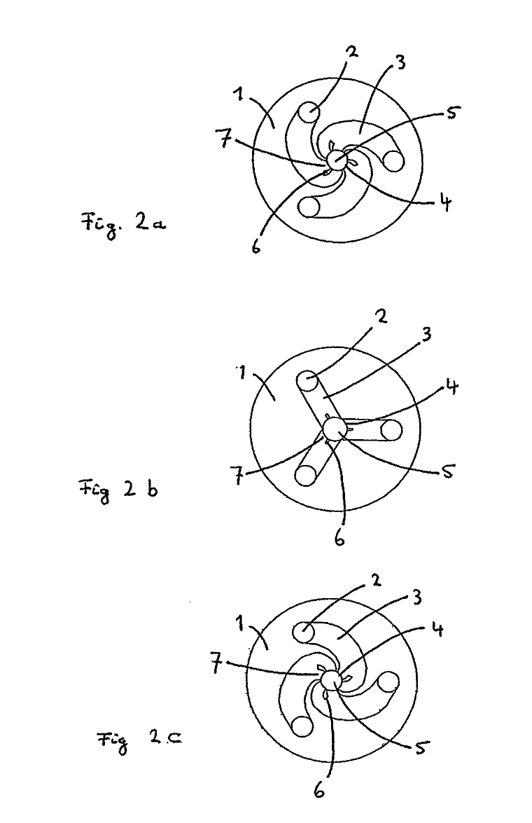

FIG. 2a-c shows mixing disks with three inlet openings for up to three different feed streams and wherein the inlet opening and outlet opening are enclosed,

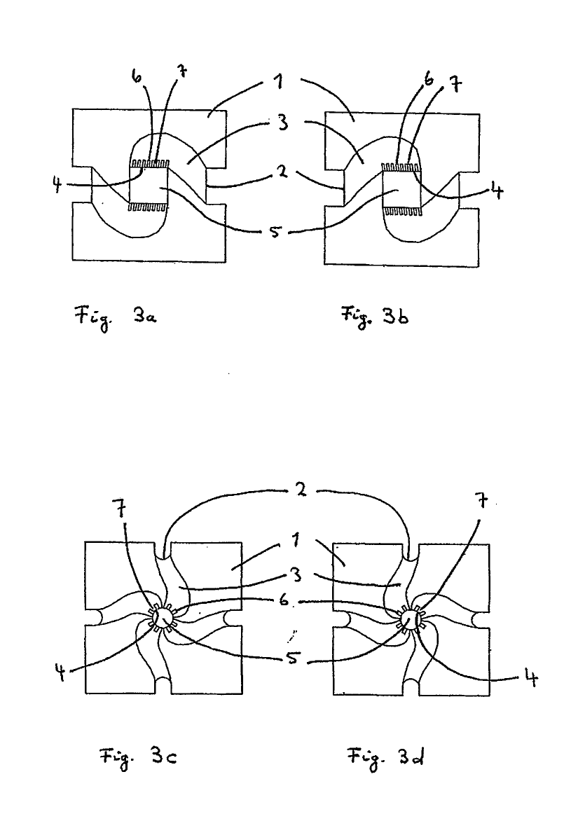

FIG. 3a-b shows mixing disks with two inlet openings at the edge of the disk for two feed streams and with an enclosed outlet opening,

FIG. 3c-d shows mixing disks with four inlet openings at the edge of the disk for up to four different feed streams and with an enclosed outlet opening,

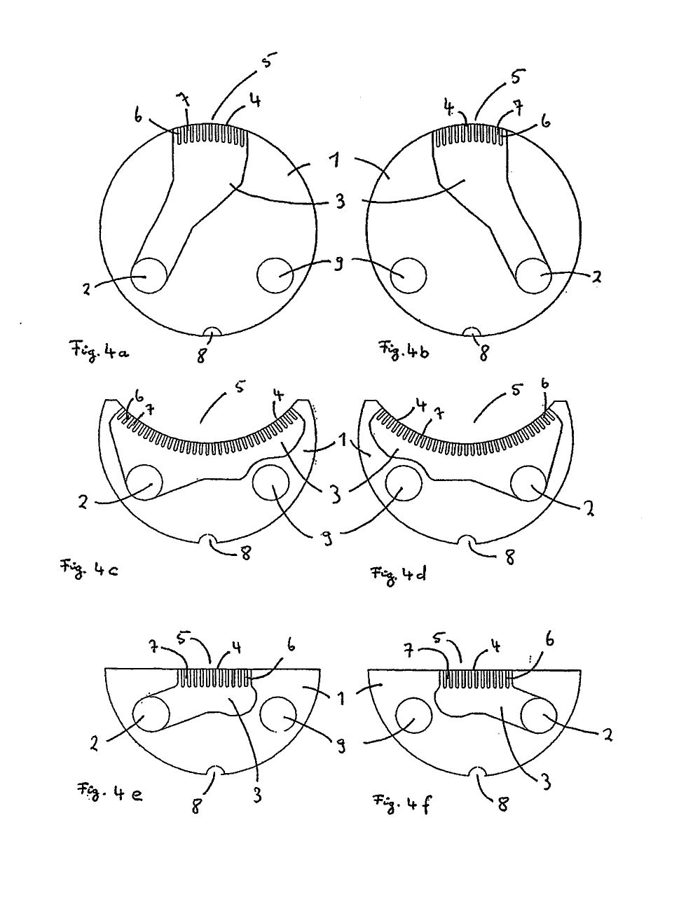

FIG. 4a-f shows mixing disks each with an enclosed inlet opening and flow-through opening for two feed streams and an outlet opening at the edge of the disk,

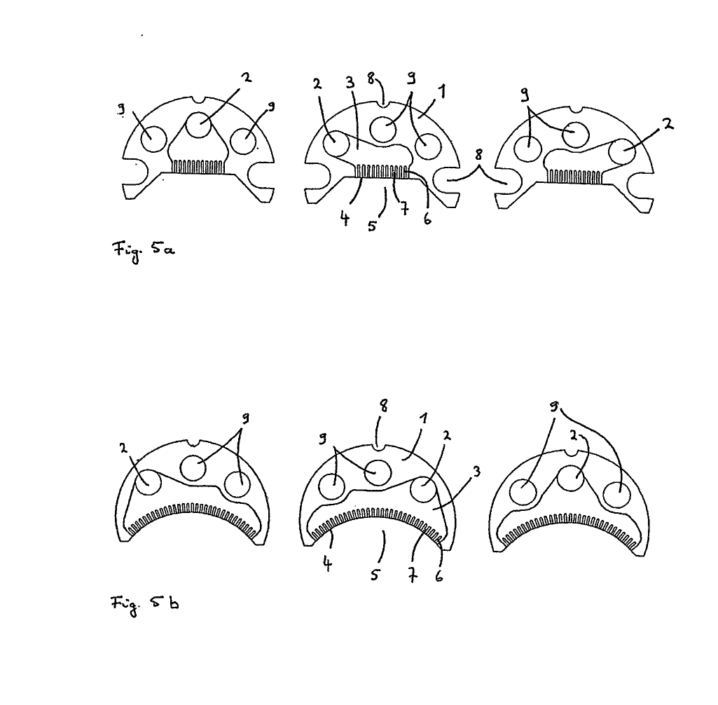

FIG. 5a-b shows mixing disks each with one enclosed inlet opening and two enclosed through-flow openings for up to three different feed streams and an outlet opening at the edge of the disk,

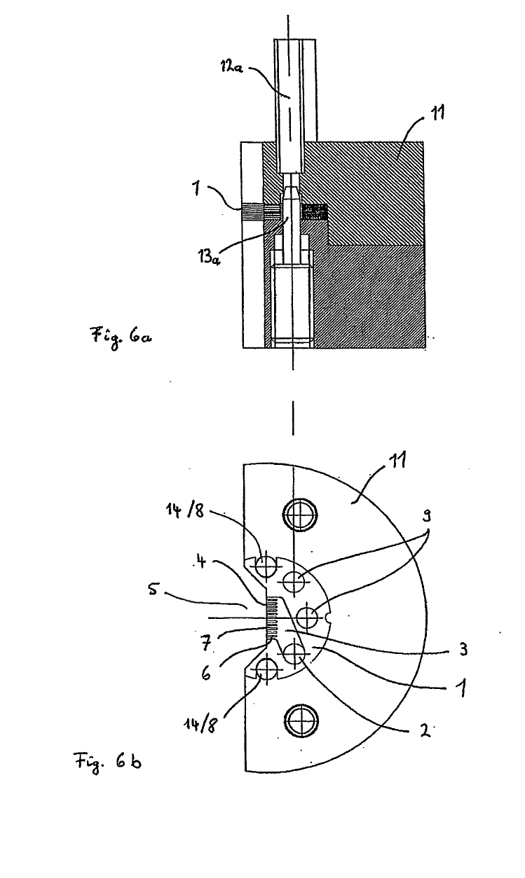

FIG. 6a shows a longitudinal section of the schematic structure of a static micromixer that can be used as a microreactor,

FIG. 6b shows a mixing disk in an open housing,

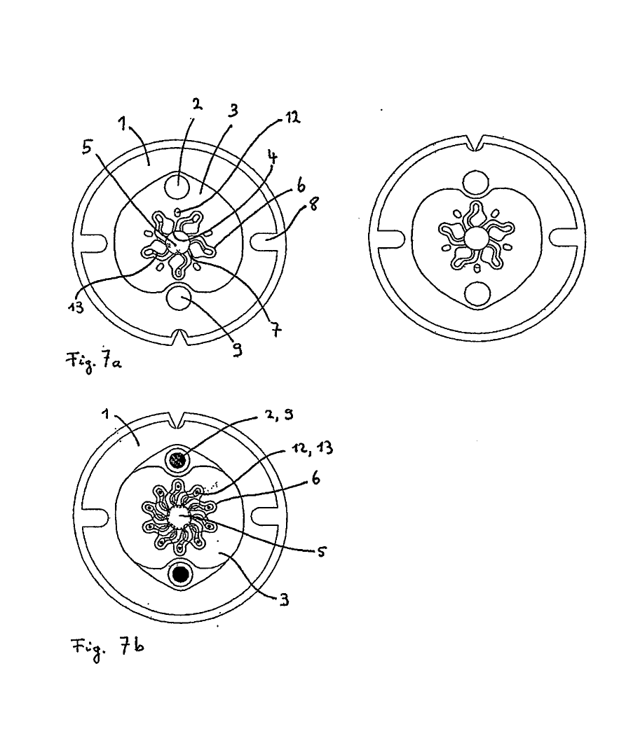

FIG. 7a-b shows mixing disks with enclosed inlet opening and through-flow opening and additional part channels, wherein different feed streams can flow through adjacent part channels,

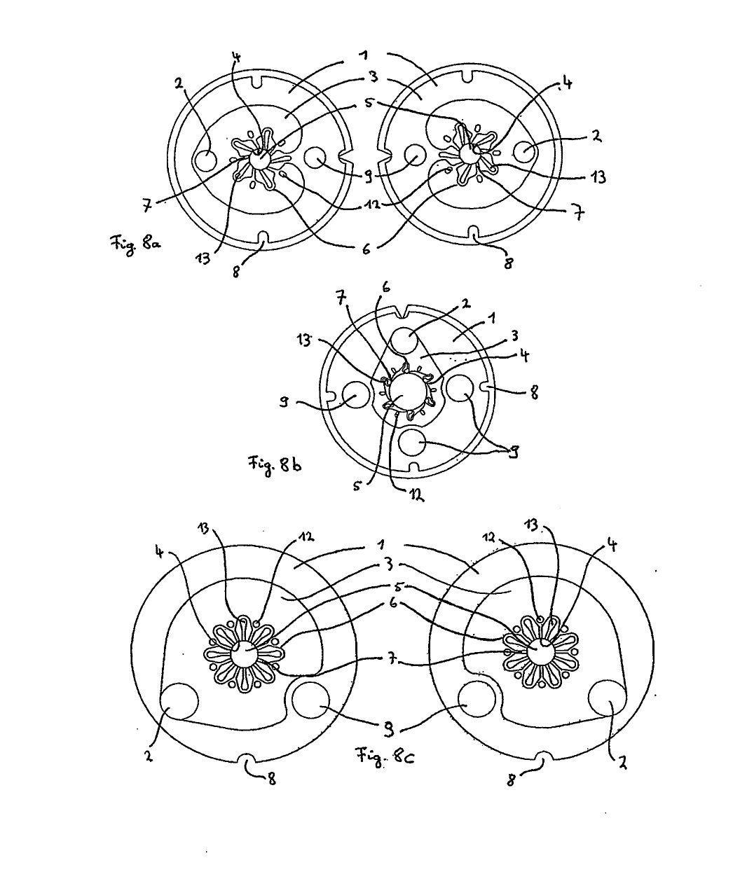

FIG. 8a,c shows mixing disks with enclosed inlet and flow-through openings and additional part channels, wherein different feed streams can flow through adjacent part channels,

FIG. 8b shows a mixing disk with enclosed inlet opening, three enclosed flow-through openings and additional part channels, wherein different feed streams can flow through adjacent part channels, and

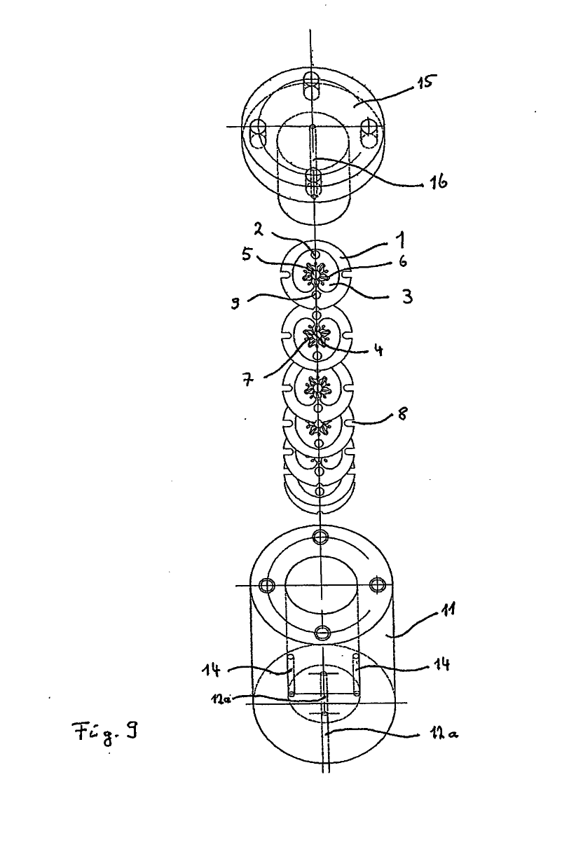

FIG. 9 shows a micromixer with a housing and a stack of several mixing disks.

One embodiment is shown in FIG. 1a and FIG. 1b. The disks (1) have two enclosed inlet openings (2). Each inlet opening (2) is connected with one linking channel (3) formed by an indentation in the plane of the disk. By a multiplicity of microstructure units (6), each linking channel (3) is divided into a multiplicity of part channels (7). Through the outlet openings (4), the part channels (7) open into an enclosed mixing zone (5). The outlet openings (4) are arranged on a circular line around the mixing zone (5). The mixing zone (5) and the inlet openings (2) are formed as through-holes in the disks. The microstructure units are bent, for example, in the form of spirals, the spirals in FIG. 1a and FIG. 1b having an opposite sense of rotation. The microstructure units, however, can also be linear or unbent. When the disks are round, they preferably have recesses (8) at the edge which can cooperate with fixing elements (14) in a housing (11) to prevent torsion or slipping. The disks, however, can also be angular, preferably quadrangular, for example in the shape of a square. In this case, the recesses and fixing elements may be omitted. Through the two inlet openings (2) two different feed streams can be introduced into the mixing zone (5) in one plane, the two outlet openings corresponding to the two different feed streams preferably being disposed opposite each other. A micromixer preferably has a stack of several components superposed on one another, with disks of the kind shown in FIG. 1a alternating with disks of the kind shown in FIG. 1b and giving rise to an arrangement consisting of an alternating layer structure ABAB etc. In this manner, two different feed streams can be fed to the mixing zone (5) directly adjacent and over and under one another. In the stack, the disks are superposed on one another in such a way that the inlet openings form subsidiary channels for introducing a particular feed stream, and the mixing zones form a main channel for removing the product stream. A fluid which later will constitute the continuous phase of the mixture, however, can also be introduced through the main channel.

Another embodiment is shown in FIG. 1c. The disk (1) has a single enclosed inlet opening (2) which is connected with a linking channel (3) formed by an indentation in the disk plane. The linking channel (3) is divided by a multiplicity of microstructure units (6) into a multiplicity of part channels (7). The part channels (7) open through the outlet openings (4) into the mixing zone (5). The outlet openings (4) are arranged on a circular line around the mixing zone (5). The mixing zone (5) and the inlet opening (2) are configured as through-holes in the disk. The microstructure units are bent, for example, in the shape of a spiral. The microstructure units, however, can also be linear, unbent or have any other geometric shape. A micromixer preferably has a stack of several components superposed on one another. In the stack, the disks are disposed above one another in a manner such that the inlet openings form a subsidiary channel for introducing a feed stream, and the mixing zones form a main channel for removing the product stream. Through the main channel can be introduced one of the components to be mixed, preferably the fluid which later will form the continuous phase of the mixture. This embodiment is particularly well suited, for example, for gassing liquids or for preparing dispersions. To this end, the liquid to be treated with the gas or the dispersing medium is introduced through the central main channel and the gas or the substance to be dispersed is introduced through the subsidiary channel. Advantageously, the stack of disks can be configured as an alternating layer structure wherein disks with spiral-shaped microstructure units (6) of opposite sense of rotation are alternately disposed one above the other. It is also possible to use only a single type of disk. The microstructure units are then preferably linear and shaped so that the part channels form nozzles.

Another embodiment is shown in FIG. 1d. The disk (1) has an enclosed inlet opening (2), an enclosed mixing zone (5) and an enclosed flow-through opening (9). The inlet opening (2) is connected with a linking channel (3) formed by an indentation in the disk plane, which channel by a multiplicity of microstructure units (6) is divided into a multiplicity of part channels (7). The part channels (7) open through the outlet openings (4) into the mixing zone (5). The outlet openings (4) are arranged on a circular line around the mixing zone (5). The mixing zone (5), inlet opening (2) and flow-through opening (9) are configured as through-holes in the disk. The microstructure units are, for example, bent in the form of spirals. The microstructures units, however, can also be linear, unbent or have any other geometric shape. With additional built-in components (10) in the linking channel, the flow conditions in the linking channel (3) can be optimized. When the disks are round, they preferably have at their edges recesses (8) that can cooperate with fixing elements 14) in a housing (11) to prevent twisting or slipping of the disks. A micromixer preferably has a stack of several disks of the kind shown in FIG. 1d and disposed above one another alternately twisted by 180°. In this manner, two different feed streams can be introduced into the mixing zone (5) directly adjacent and above and under one another. In the stack, the disks are superposed on one another in a manner such that the inlet openings (2) and the flow-through openings (9) alternate and form two subsidiary channels for introducing two feed streams, the mixing zones forming a main channel for removing the product stream. A fluid which later will constitute the continuous phase of the mixture, however, can also be introduced through the main channel. Advantageously, the stack of disks can have a configuration with an alternating layer structure wherein disks with spiral-shaped microstructure units (6) of opposite sense of rotation are disposed alternately one above the other. A single type of disk, however, can also be used. The microstructure units are preferably linear and configured in such a way that the part channels form nozzles.

FIGS. 2a to 2c show another embodiment. Each of the disks (1) has three enclosed inlet openings (2). Each inlet opening (2) is connected with a linking channel (3) formed by an indentation in the plane of the disk. Each linking channel (3) is divided by at least one microstructure unit (6) into at least two part channels (7). By means of a larger number of microstructure units, division into a higher number of part channels can be achieved. Through the outlet openings (4), the part channels (7) open into the mixing zone (5). The outlet openings (4) are arranged on a circular line around the mixing zone (5). The mixing zone (5) and the inlet openings (2) are configured as through-holes in the disks. The microstructure units can be in the form of spirals having a different sense of rotation or they can be linear. Through the three inlet openings (2), equal feed streams or up to three different feed streams can be introduced into the mixing zone (5) in one plane. A micromixer preferably has a stack of several components disposed one above another wherein different types of disks as shown in FIGS. 2a, 2b and 2c alternate forming an alternating layer structure, for example ABCABC. In this manner, two different feed streams can be introduced into the mixing zone (5) directly adjacent and over and under one another. In the stack, the disks are disposed above one another so that the inlet openings form subsidiary channels for introducing a particular feed stream, and the mixing zones form a main channel for removing the product stream. A fluid which later will constitute the continuous phase of the mixture, however, can also be introduced through the main channel.

Another embodiment is shown in FIG. 3a and FIG. 3b. The disks (1) have two inlet openings positioned at the edge of the disk. Each inlet opening (2) is connected with a linking channel (3) formed by an indentation in the plane of the disk. Each linking channel (3) is divided by a multiplicity of microstructure units (6) into a multiplicity of part channels (7). Through the outlet openings (4), the part channels (7) open into an enclosed mixing zone (5). The outlet openings (4) are arranged on a circular line. The mixing zone (5) is configured, for example, as a rectangular through-hole in the disks. The microstructure units are disposed, for example, at a slant to the direction of flow, the inclinations in FIGS. 1 and 1b extending in opposite directions. The microstructure units, however, can also have the same inclination or no inclination at all. The disks have an approximately quadrangular basic shape, but they can also have any other basic geometric shape (angular, round, elliptical etc). Through the two inlet openings (2), two different feed streams can be introduced into the mixing zone (5) in one plane, with the two outlet openings for the two different feed streams preferably disposed opposite each other. A micromixer preferably has a stack of several components disposed above one another wherein disks of the kind shown in FIG. 3a alternate with disks of the kind shown in FIG. 3b forming an alternating layer structure ABAB. In this manner, two different feed streams can be introduced into the mixing zone (5) directly adjacent and over and under one another. In the stack, the disks are disposed above one another so that the inlet openings together with the mixer housing form at the edge of the mixer subsidiary channels for introducing a particular feed stream, and inside the mixer the mixing zones form a main channel for removing the product stream. A fluid later constituting the continuous phase of the mixture, however, can also be introduced through the main channel.

Another embodiment is shown in FIG. 3c and FIG. 3d. Each disk (1) has four inlet openings (2) positioned at the edge of the disk. Each inlet opening (2) is connected with a linking channel (3) formed by an indentation in the plane of the disk. Each linking channel (3) is divided by several microstructure units (6) into several part channels (7). Through the outlet openings (4), the part channels (7) open into an enclosed mixing zone (5). The outlet openings (4) are arranged on a circular line. The linking channels are bent into spiral shapes, the spirals in FIGS. 3c and 3d having an opposite sense of rotation. The mixing zone (5) is configured as a through-hole in the disks. The microstructure units are, for example, straight, but they can also be bent at an angle or bent like a spiral. The disks have an approximately square basic shape, but they can also have any other basic geometric shape (angular, round, elliptical etc). Through the four inlet openings (2), equal feed streams or up to four different feed streams can be introduced into the mixing zone (5) in one plane, with the outlet openings for the different feed streams preferably disposed opposite one another. A micromixer preferably has a stack of several components disposed above one another wherein disks of the kind shown in FIG. 3c alternate with disks of the kind shown in FIG. 3d and having a sense of rotation opposite to that of spiral-shaped linking channels, thus forming an alternating layer structure ABAB. In this manner, two different feed streams can be introduced into the mixing zone (5) directly adjacent and over and under one another. In the stack, the disks are disposed above one another so that the inlet openings together with the mixer housing form at the edge of the mixer subsidiary channels for introducing a particular feed stream, and inside the mixer the mixing zones form a main channel for removing the product stream. A fluid which later will constitute the continuous phase of the mixture, however, can also be introduced through the main channel.

Additional embodiments are shown in FIG. 4a to FIG. 4f. Each disk (1) has an enclosed inlet opening (2) and an enclosed flow-through opening (9). Each inlet opening (2) is connected with a linking channel (3) formed by an indentation in the plane of the disk. By a multiplicity of microstructure units (6), each linking channel (3) is divided into a multiplicity of part channels (7). Through outlet openings (4) arranged at the edge of the disks, the part channels (7) open into the mixing zone (5) disposed outside the plane of the disk. The outlet openings (4) can be arranged on straight lines (FIGS. 4e, 4f) or on arc segments, the arc segments being convex (FIGS. 4a, 4b) or concave (FIGS. 4c, 4d). The inlet openings (2) and the flow-through openings (9) are configured as through-holes in the disks. The microstructure units can be parallel or they can be arranged at various angles to the flow direction preset by the linking channel. When the disks are round, they preferably have at their edge recesses (8) which can cooperate with fixing elements (14) in a housing (11) to prevent twisting or slipping of the disks. A micromixer preferably has a stack of several components disposed above one another, the disks of the kind shown in FIG. 4a alternating with disks of the kind shown in FIG. 4b, or disks of the kind shown in FIG. 4c alternating with disks of the kind shown in FIG. 4d, or disks of the kind shown in FIG. 4e alternating with disks of the kind shown in FIG. 4f, giving rise to an alternating layer structure ABAB. In this manner, two different feed streams can be fed to the mixing zone (5) directly adjacent and over and under one another. Preferably, the angles at which the part channels open into the mixing zone are different relative to the circumferential line of the mixing zone in adjacent disks and preferably have opposite deviations of 90°. In the stack, the disks are disposed over one another in a manner such that the inlet openings (2) and the flow-through openings (9) alternate and inside the mixer form two subsidiary channels for introducing two feed streams. The mixing zone and a housing can form a main channel for removing the product stream, the mixing zone also possibly being open to the surroundings. The outwardly open configuration is particularly preferred if the micromixer is a microreactor for burning fluid media, for example combustible gases or liquids. An embodiment configured as a gas reactor has at least one first connection for supplying a combustible medium and at least one second connection for supplying a burning reaction-promoting medium, particularly an oxygen-containing gas, for example air. The burnable medium and the medium promoting the burning can each be supplied through one of the two subsidiary channels.

Other embodiments are shown in FIG. 5a and FIG. 5b. Each of the disks (1) has an enclosed inlet opening (2) and two enclosed flow-through openings (9). Each inlet opening (2) is connected with a linking channel (3) formed by an indentation in the plane of the disk. By a multiplicity of microstructure units (6), each linking channel (3) is divided into a multiplicity of part channels (7). Through outlet openings (4) arranged at the edge of the disks, the part channels (7) open into the mixing zone (5) disposed outside the plane of the disk. The outlet openings (4) can be arranged on straight lines (FIG. 5a) or on arc segments (FIG. 5b), the arc segments being convex or concave. The inlet openings (2) and the flow-through openings (9) are configured as through-holes in the disks. The microstructure units can be parallel or they can be arranged at various angles to the flow direction preset by the linking channel. When the disks are round, they preferably have at their edge recesses (8) which can cooperate with fixing elements (14) in a housing (11) to prevent twisting or slipping of the disks. A micromixer preferably has a stack of several components disposed above one another, the disks of the three different kinds shown in FIG. 5a alternating with those of the kind shown in FIG. 5b giving rise to an alternating layer structure ABCABC. In this manner, two different feed streams can be fed to the mixing zone (5) directly adjacent and over and under one another. Preferably, the angles at which the part channels open into the mixing zone differ relative to the circumferential line of the mixing zone in adjacent disks, opposite deviations of 90° being particularly preferred. In the stack, the disks (1) are disposed over one another in a manner such that the inlet openings (2) and the flow-through openings (9) alternate and inside the mixer form three subsidiary channels for introducing up to three different feed streams. The mixing zone (5) and a housing can form a main channel for removing the product stream, the mixing zone also possibly being open to the surroundings. The outwardly open configuration is particularly preferred when the micromixer is a microreactor for burning fluid media, for example burnable gases or liquids.

FIG. 6a shows the schematic structure of an embodiment of a static micromixer in longitudinal section. A housing (11) is provided with fluid inlets (12a). The housing (11) contains a stack of several mixer disks (1) of the invention. The inlet openings and/or flow-through openings of the disks can be closed and opened by means of a closure (13a) which is preferably displaceable perpendicularly to the plane of the disk. The micromixer can be used as a reactor for carrying out chemical reactions, particularly as a gas burner.

In the case of combustion reactors, the mixing zone in which the combustion reaction takes place can be located outside the housing. In the case of other chemical reactors and mixers, the mixing zone can be located within the housing, and the mixture can be removed through an appropriate fluid outlet. In combustion reactors, a suitable ignition mechanism and/or a starting or auxiliary flame is preferably provided in spatial vicinity of the mixing zone.

FIG. 6b shows the cross-section of a static mixer. Into a housing (11) is built a mixer disk (1) held in position by means of recesses (8) and fixing elements (14). The mixer disk is, for example, of the kind shown in FIG. 5a.

Other, preferred embodiments are shown in FIGS. 7a-b and FIGS. 8a-c. In these embodiments, the disks (1) have adjacent part channels (7) and (13) through which different feed streams can flow alternately so that different feed streams can be introduced into the mixing zone (5) directly adjacent in one plane.

Each of the disks (1) shown in FIG. 7a has an enclosed inlet opening (2), an enclosed mixing zone (5) and an enclosed flow-through opening (9). The inlet opening (2) is connected with a linking channel (3) formed by an indentation in the plane of the disk, said linking channel being divided into a multiplicity of part channels (7) by a multiplicity of microstructure units (6). Through the outlet openings (4), the part channels (7) open into the mixing zone (5). The outlet openings (4) are arranged on a circular line around the mixing zone (5). The mixing zone (5), the inlet opening (2) and the flow-through opening (9) are configured as through-holes in the disk. Into the microstructure units (6) are integrated other part channels (13) configured as indentations and which are shielded against the linking channel (3) and open into the mixing zone (5). The part channels (7) and the other part channels (13) are alternately disposed adjacent to each other. The disks are provided with additional through-holes (12), the number of the through-holes (12) and the number of the additional part channels (13) being identical. The through-holes (12) are arranged so that when a disk (1) is placed on a second disk (1) twisted by 180° they are disposed above the additional part channels (13) of the disk that is positioned underneath. A feed stream flowing through the inlet opening (2) into the linking channel (3) can flow through the through-holes (12) into an additional part channel (13) of a disk positioned underneath. The angle formed between the adjacent part channels (7) and (13) and the angle relative to the circumferential line of the mixing zone can be different. In FIG. 7a, the angles of the part channels (7) and of the additional part channels (13) relative to the circumferential line of the mixing zone (5) have opposite deviations of 90°. As a result, the outlet openings of each two part channels form a pair. In this manner, two different feed streams can be introduced on top of each other. The part channels, however, can also run parallel, at right angles or inclined toward the mixing zone. FIG. 7a shows next to each other two identical disks (1) twisted by 180°. FIG. 7b shows schematically two superposed disks twisted by 180°. A micromixer preferably has a stack of several superposed components wherein disks of the kind shown in FIG. 7a twisted by 180° are alternately superposed on one another. In this manner, two different feed streams can be fed to the mixing zone (5) both directly adjacent and over and under one another and also directly adjacent and next to each other. In the stack, the disks are disposed above one another so that the inlet openings (2) and the flow-through openings (9) alternate and form two subsidiary channels for introducing two feed streams, and the mixing zones form a main channel for removing the product stream. A fluid which later will constitute the continuous phase of the mixture, however, can also be introduced through the main channel. Moreover, the disks are disposed above one another so that each additional through-hole (12) of a disk is connected in communicating manner with one corresponding additional part channel (13) of an adjacent disk.

FIG. 8a shows an embodiment similar to that of FIG. 7a the difference being that the part channels (7) and the additional part channels (13) lead to the mixing zone (5) in parallel and inclined at identical angles. The disk on the left in FIG. 8a differs from the disk on the right in that the angle formed between the part channels (7) and (13) and the circumferential line of the mixing zone (5) has an opposite deviation of 90°. A micromixer preferably has a stack of several superposed components wherein the left and the right disks shown in FIG. 8a alternate giving rise to an alternating layer structure ABAB. In this manner, two different feed streams can be introduced into the mixing zone (5) directly adjacent and over and under each other at opposite angles.

FIG. 8c shows an embodiment similar to that of FIG. 8a the difference being that the part channels (7) and the additional part channels (13) lead to the mixing zone (5) in parallel and vertically. A micromixer preferably has a stack of several superposed components wherein the left and right disks of the kind shown in FIG. 8c alternate resulting in an alternating layer structure ABAB. In the stack, the disks are superposed on one another so that the inlet openings (2) and the flow-through openings (9) alternate and form two subsidiary channels for introducing two feed streams and the mixing zones form a main channel for removing the product stream. Moreover, the disks are superposed on one another so that each additional through-hole (12) of a disk is connected in communicating manner with a corresponding additional part channel (13) of an adjacent disk. In this manner, two different feed streams can be introduced into the mixing zone (5) both directly adjacent and over and under each other and directly adjacent and next to each other.

Another embodiment is shown in FIG. 8b. A disk (1) has an enclosed inlet opening (2), three enclosed flow-through openings (9) and one enclosed mixing zone (5). The inlet opening (2) is connected with a linking channel (3) formed by an indentation in the plane of the disk and which by a multiplicity of microstructure units (6) is divided into a multiplicity of part channels (7). Through the outlet openings (4), the part channels (7) open into the mixing zone (5). The outlet openings (4) are arranged on a circular line around the mixing zone (5). The mixing zone (5), the inlet opening (2) and the flow-through opening (9) are configured as through-holes in the disk. Into the microstructure units (6) are integrated in indented manner additional part channels (13) which are shielded against the linking channel (3) and which open into the mixing zone (5). The part channels (7) and the additional part channels (13) are disposed alternately adjacent to each other. The disks have additional through-holes (12), the number of the through-holes (12) and the number of the additional part channels (13) being identical. The through-holes (12) are arranged so that when a disk (1) twisted by 90° is placed on a second disk (1) they are positioned above the additional part channels (13) of the disk located underneath. A feed stream flowing through the inlet opening (2) into the linking channel (3) can flow through the through-holes (2) into the additional part channel (13) of a disk positioned below. The angle formed by the adjacent part channels (7) and (13) and the angle relative to the circumferential line of the mixing zone can be different. In FIG. 8b the angles of the part channels (7) compared to the angles of the additional part channels (13) have an opposed deviation of 90° relative to the circumferential line of the mixing zone (5). As a result, the outlet openings of each two part channels form a pair. In this manner, two different feed streams can be introduced on top of each other. The part channels, however, can also run parallel at a right angle or inclined toward the mixing zone. A micromixer preferably has a stack of several superposed components, the disks being disposed above one another with disks of the kind shown in FIG. 8b being disposed above one another in any order and each being twisted by 90°, 180° or 270°. In this manner, different feed streams can be introduced into the mixing zone (5) either directly adjacent and over and under one another or directly adjacent and next to each other. Overall, up to four different feed streams can be mixed by means of the micromixer. In the stack, the disks are superposed on one another so that the inlet openings (2) and the flow-through openings (9) alternate and form a total of four subsidiary channels for introducing up to four feed streams and the mixing zones form a main channel for removing the product stream. A fluid which later will constitute the continuous phase of the mixture, however, can also be introduced through the main channel. Moreover, the disks are superposed on one another so that each additional through-hole (12) of a disk is connected in communicating manner with the corresponding additional part channel (13) of an adjacent disk.

In FIG. 9 is shown as an example a possible embodiment of a micromixer of the invention in an exploded view. A housing (11) contains a stack of components of the invention in the form of disks (1). Shown as an example is a stack of several disks of the kind shown in FIG. 8a, but other disks of the invention can also be used, in which case optionally the shape of the housing, the number and position of the inlets and outlets of the fluid etc must be correspondingly adapted. The disks (1) are positioned so that the recesses (8) cooperate with the fixing elements (14) so as to prevent the twisting of the disks. The housing has two fluid inlets (12a) for introducing the feed streams. The housing can be closed with a cover (15) containing the fluid outlet (16).

### LIST OF REFERENCE NUMERALS

1 disk
2 inlet opening
3 linking channel
4 outlet opening
5 mixing zone
6 microstructure unit
7 part channel
8 recess
9 flow-through opening
10 built-in components
11 housing
12 through-hole
12a fluid inlet
13 additional part channel
13a closure
14 fixing element
15 cover
16 fluid outlet

1. Component for a static micromixer in the form of a disk (1) which
has at least one inlet opening (2) for the introduction of at least one feed stream into a linking channel (3) disposed in the plane of the disk and at least one outlet opening (4) for the outflow of the feed stream into a mixing zone (5) disposed in the plane of the disk,
wherein the inlet opening (2) is connected with the outlet opening (4) in a communicating manner through the linking channel (3) disposed in the plane of the disk, and
wherein the linking channel (3) before opening into the mixing zone (5) is divided by microstructure units (6) into two or more part channels (7), the widths of the part channels being in the millimeter to submillimeter range and being smaller than the width of the mixing zone (5).

2. Component as defined in claim 1, characterized in that the widths of the part channels (7) at their opening into the mixing zone are from 1 μm to 2 mm.

3. Component as defined in claim 1, characterized in that the ratio of the greatest width of the linking channel (3) and/or of the width of the inlet opening (2) to the width of the part channels (7) is greater than 2.

4. Component as defined in claim 1, characterized in that the ratio of the length to the width of the part channels (7) is from 1:1 to 20:1.

5. Component as defined in claim 1, characterized in that the ratio of the width of the mixing zone (5) to the width of the part channels (7) is greater than 2.

6. Component as defined in claim 1, characterized in that additionally it has at least one flow-through opening (9).

7. Component as defined in claim 1, characterized in that at least one of the inlet openings (2) or flow-through openings (9) or the mixing zone (5) is enclosed by the plane of the disk and that the linking channel (3) is formed by an indentation.

8. Component as defined in claim 1, characterized in that at least one of the inlet openings (2) or flow-through openings (9) or the mixing zone (5) is disposed at the edge of the disk or as a recess at the edge of the disk.

9. Component as defined in claim 1, characterized in that there are present at least two inlet openings (2) for at least two different feed streams, each inlet opening (2) being connected with the mixing zone (5) through the linking channel (3).

10. Component as defined in claim 9, characterized in that there are present two inlet openings (2) for two different feed streams, each inlet opening (2) being connected with the mixing zone (5) through one linking channel (3) and the outlet openings (4) of the two linking channels (3) being disposed opposite one another.

11. Component as defined in claim 1, characterized in that the outlet openings (4) are arranged on a circular line.

12. Component as defined in claim 1, characterized in that it has additional through-holes (12) and additional part channels (13) the latter being integrated into the microstructure units (6) and being separated from the part channels (7).

13. Static micromixer which has
a housing (11) with at least 2 fluid inlets (12a) and at least one fluid outlet (16) and
at least two disks as defined in claim 1 arranged into a stack in the housing (11),
wherein the disks (1) are superposed on one another so that the inlet openings (2) form subsidiary channels for introducing a particular feed stream and the mixing zones (5) form a main channel for removing the product stream, and the main and subsidiary channels extend through the stack.

14. Micromixer as defined in claim 13, characterized in that the linking channels (3) of the disks (1) are formed by indentations and that the linking channels (3), before opening into the mixing zone (5), are divided into part channels (7) by the microstructure units (6) provided on the disks.

15. Micromixer as defined in claim 13, characterized in that the linking channels (3) of the disks (1) are formed by recesses in the disks (1), the disks (1) being arranged as intermediate disks between a cover disk and a bottom disk, and that the linking channels (3) before opening into the mixing zone (5) are divided into part channels (7) by microstructure units (6) provided on the cover disks and/or bottom disks.

16. Micromixer as defined in claim 13, characterized in that it has an integrated heat exchanger.

17. Combustion reactor having a micromixer with at least one component as defined in claim 1, at least one first connection for introducing a combustible liquid or gaseous medium, and at least one second connection for introducing a combustion reaction-promoting medium.

18. Mixing process whereby at least two fluid feed streams, at first kept separated, are mixed with each other, characterized in that the mixing is carried out by use of at least one component as defined in claim 1.

19. Process as defined in claim 18, characterized in that the flow rate at which the feed stream is fed to the mixing zone is greater than the flow rate of the product stream within the mixing zone.

20. Process for producing dispersions or solutions whereby a continuous liquid phase is mixed with at least one insoluble fluid phase that is to be dispersed or with at least one soluble fluid phase, characterized in that the mixing is carried out by use of a component as defined in claim 1.

21. Process as defined in claim 20, characterized in that the continuous phase is conveyed through the main channel and the phase to be dispersed or dissolved is conveyed through at least one subsidiary channel of a micromixer.

22. Process for carrying out chemical reactions whereby
at least two fluid feed streams, at first kept separated, and which contain or consist of reactive constituents are mixed with one another and whereby
during or after the mixing a chemical reaction takes place among the constituents spontaneously or induced by a supply of energy or by a suitable catalyst,
characterized in that the mixing is carried out by use of at least one component as defined in claim 1.

23. Use of microcomponents as defined in claim 1 for mixing, homogenizing, dispersing, emulsifying, dissolving or gassing liquids or for carrying out chemical reactions.
